(19) United States
(12) Patent Application Publication
(10) Pub. No.: US 2012/0171950 A1
(43) Pub. Date: Jul. 5, 2012

(54) METHOD AND SYSTEM FOR PROVIDING PERSONAL BROADCASTING SERVICE

(75) Inventors: Michael Shin, Seongnam-si (KR); Joon-Kyu Moon, Suwon-si (KR); Woo-Jun Choi, Hwaseong-si (KR); Hye-Young Sheen, Suwon-si (KR); Sang-Wook Woo, Suwon-si (KR); Ji-Hoon Lee, Suwon-si (KR); Jae-Seung Yoon, Yongin-si (KR)

(73) Assignee: SAMSUNG ELECTRONICS CO., LTD, .Suwon-si (KR)

(21) Appl. No.: 13/343,217

(22) Filed: Jan. 4, 2012

(30) Foreign Application Priority Data
Jan. 4, 2011 (KR) 10-2011-0000478

(51) Int. Cl. H04W 4/06

(52) U.S. Cl. 455/3.01

(57) ABSTRACT

Provided is a method for providing a personal broadcasting service. The method includes receiving a request for a broadcast theme or content from a broadcast receiving terminal, searching for broadcast providing terminals configured to provide a personal broadcast associated with the broadcast theme or content, selecting one of the searched broadcast providing terminals, and providing, when a personal broadcast registration request is received from the selected broadcast providing terminal, information associated with the requested personal broadcast to the broadcast receiving terminal.

### CROSS-REFERENCE TO RELATED APPLICATION AND CLAIM OF PRIORITY

The present application is related to and claims priority under 35 U.S.C. §119 to an application filed in the Korean Intellectual Property Office on Jan. 4, 2011 and assigned Serial No. 10-2011-0000478, the contents of which are incorporated herein by reference.

### TECHNICAL FIELD OF THE INVENTION

The present invention generally relates to broadcasting services, and more particularly, to a method and system for providing a personal broadcasting service.

### BACKGROUND OF THE INVENTION

Electronic communication industries have developed various portable terminals, such as mobile communication terminals (cellular phones), electronic note devices, and personal digital assistants (PDAs) that are becoming necessities in modern society. These portable terminals have become an important means for information dissemination that is rapidly changing.

As is well known in the art, the Internet is in widespread use and portable terminals are providing various Internet-based services. The Internet is an open network that provides various services using an Internet Protocol (IP). Examples of such services include Electronic Mail (E-mail), Remote Computer Connection, File Transfer, Internet Information Retrieval, Internet Conversations and Discussions, Electronic Bulletin Board (BBS), Hypertext Information Access, and Online Gaming.

Recently developed portable terminals often have a video capturing function in addition to basic communication functions from which users may share videos that are being captured by these portable terminals in real time through the Internet. For example, the portable terminals may provide a personal broadcast service through the Internet and may receive a personal broadcast from another portable terminal through the Internet. Recently, more and more personal users desire to advertise themselves or produce personal broadcasts for various fields of interest.

In general, in order to view a personal broadcast of a desired theme, a user may search for a particular personal broadcast by accessing a server providing a personal broadcasting service. If a personal broadcast of a desired theme is not searched for or if the searched personal broadcast is provided in an undesired time zone, the user may be restricted from viewing the personal broadcast. That is, because the broadcast theme and the broadcast time are determined by the broadcast provider, the viewer may encounter a limitation in viewing a personal broadcast.

### SUMMARY OF THE INVENTION

To address the above-discussed deficiencies of the prior art, it is a primary aspect of the present invention to solve at least the above problems and/or disadvantages and to provide some, none, or all of the advantages described below. Accordingly, an aspect of the present invention is to provide a method and system for providing a personal broadcasting service for viewing a personal broadcast having a desired theme or content.

Another object of the present invention is to provide a method and system for providing a personal broadcasting service to enable a personal broadcast provider to provide a personal broadcast according to a theme or content requested by a viewer.

Another object of the present invention is to provide a method and system for providing a personal broadcasting service that searches for a personal broadcast provider configured to provide a personal broadcast of a desired theme or content requested by a viewer, and notify the viewer with information about an initiation of the personal broadcast to be provided by the personal broadcast provider.

Another object of the present invention is to provide a method and system for providing a personal broadcasting service that may provide a mutually satisfactory personal broadcast by communication between a viewer and a personal broadcast provider.

In accordance with an embodiment of the present invention, a method for providing a personal broadcasting service is provided. The method includes receiving a request for a broadcast theme or content from a broadcast receiving terminal, searching for broadcast providing terminals configured to provide a personal broadcast of the broadcast theme or content; selecting one of the searched broadcast providing terminals, and when a personal broadcast registration request is received from the selected broadcast providing terminal, providing information associated with requested personal broadcast to the broadcast receiving terminal.

In accordance with an embodiment of the present invention, a system for providing a personal broadcasting service is provided. The system includes a broadcast receiving terminal for requesting a broadcast from a server, a server for receiving a request for a broadcast theme or content from a broadcast receiving terminal, and searching for and selecting broadcast providing terminals configured to provide a personal broadcast of the broadcast theme or content. The broadcast providing terminal is configured to transmit a personal broadcast registration request to the server, such that, when a personal broadcast registration request is received from the selected broadcast providing terminal, the server provides information associated with the requested personal broadcast to the broadcast receiving terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates an example schematic diagram for a personal broadcast providing system according to an embodiment of the present invention;

FIG. 2 illustrates an example block diagram of a personal broadcast server according to an embodiment of the present invention;

FIG. 3 illustrates an example communication flow diagram of the personal broadcast providing system according to an embodiment of the present invention;

FIG. 4 illustrates an example flow diagram for a process of searching for a broadcast provider configured to provide a broadcast of a content desired by a viewer, by the personal broadcast server according to an embodiment of the present invention;

FIG. 5 illustrates an example flow diagram for a process of searching for a broadcast provider configured to provide a broadcast of a content desired by a viewer, by the personal broadcast server according to another embodiment of the present invention;

FIG. 6 illustrates an example flow diagram for a process of searching for a broadcast provider configured to provide a broadcast of a content desired by a viewer, by the personal broadcast server according to another embodiment of the present invention;

FIG. 7 illustrates an example diagram for a method of determining a search condition for a broadcast provider configured to provide a broadcast of a theme and content desired by a viewer, by the personal broadcast server (function server) according to an embodiment of the present invention; and

FIGS. 8A and 8B illustrate example diagrams for a method of searching for and prioritizing broadcast providers configured to provide a broadcast of a content desired by a viewer, according to an embodiment of the present invention.

### DETAILED DESCRIPTION OF THE INVENTION

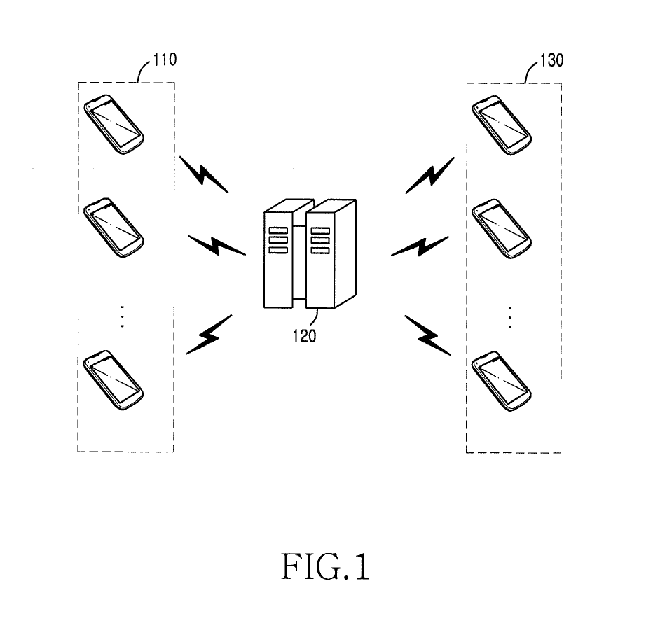

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged personal broadcast systems. Exemplary embodiments of the present invention will be described herein below with reference to the accompanying drawings. In the following description, detailed descriptions of well-known functions or configurations will be omitted since they would unnecessarily obscure the subject matters of the present invention. Also, the terms used herein are defined according to the functions of the present invention. Thus, the terms may vary depending on users' or operators' intentions or practices. Therefore, the terms used herein must be understood based on the descriptions made herein.

The present invention relates to a method and system for providing a personal broadcasting service, and in particular, to a method and system for providing a personal broadcasting service to provide a view of a personal broadcast of a desired theme or content. A personal broadcasting system according to an embodiment of the present invention searches for a personal broadcast provider configured to provide a personal broadcast of a desired theme requested by a viewer, and notify the viewer of information associated with initiation of the personal broadcast to be provided by the personal broadcast provider.

FIG. 1 illustrates an example schematic diagram for a personal broadcast providing system according to an embodiment of the present invention.

Referring to FIG. 1, a personal broadcast providing system according to an embodiment of the present invention may include one or more personal broadcast server 120, broadcast receiving terminals 110, and broadcast providing terminals 130. The personal broadcast server 120 is configured to provide a personal broadcasting service. The broadcast receiving terminals 110 access the personal broadcast server 120 to receive personal broadcasts. The broadcast providing terminals 130 access the personal broadcast server 120 to receive personal broadcasts.

A user of the broadcast receiving terminal (hereinafter referred to as a viewer) requests a personal broadcast of a desired theme or content from the personal broadcast server 120. The viewer may request a desired broadcast in accordance with a registration procedure using a user interface provided by the personal broadcast server 120. For example, the viewer may register one or more characteristics, such as a desired viewing theme, time, and region in a bulletin board. Also, the viewer may register a desired broadcast by entering entries in a form that are classified in multiple differing categories. The personal broadcast server 120 searches for a suitable broadcast providing terminal (hereinafter referred to as a broadcast provider) and notifies the requested theme or content to the broadcast provider. For example, the personal broadcast server 120 analyzes the contents of an application registered by the viewer, and searches for and selects one or more suitable broadcast providers. This will be described below in detail with reference to the drawings.

Thereafter, when the broadcast provider requests registration of a personal broadcast, the personal broadcast server 120 generates and allocates a channel for the personal broadcast and registers broadcast information including an address of the allocated channel. For example, personal broadcast-related information may be registered in a bulletin board of the personal broadcast server. The personal broadcast-related information may include a channel address, a broadcast content, and a broadcast time. The broadcast provider transmits personal broadcast data, captured by the broadcast provider itself, to the personal broadcast server 120. The personal broadcast server 120 processes the personal broadcast data and provides a personal broadcast through the allocated channel. Herein, the personal broadcast server 120 may notify the broadcast receiving terminal (viewer) of the personal broadcast using the broadcast providing terminal such that the viewer may view the personal broadcast by accessing the channel address detected from the broadcast information registered in the personal broadcast server 120.

The present invention is not limited to the specific embodiment described above. For example, when a channel for a personal broadcast of the broadcast providing terminal is generated and allocated, the personal broadcast server 120 may notify the broadcast receiving terminal of the establishment of the channel for the personal broadcast and may also request participation in the channel. Herein, when requesting participation in the personal broadcast, the personal broadcast server 120 may provide a broadcast content and a broadcast time to the broadcast receiving terminal or may register the same in the bulletin board. The broadcast receiving terminal having accepted the participation request may automatically participate in the channel and receive the personal broadcast.

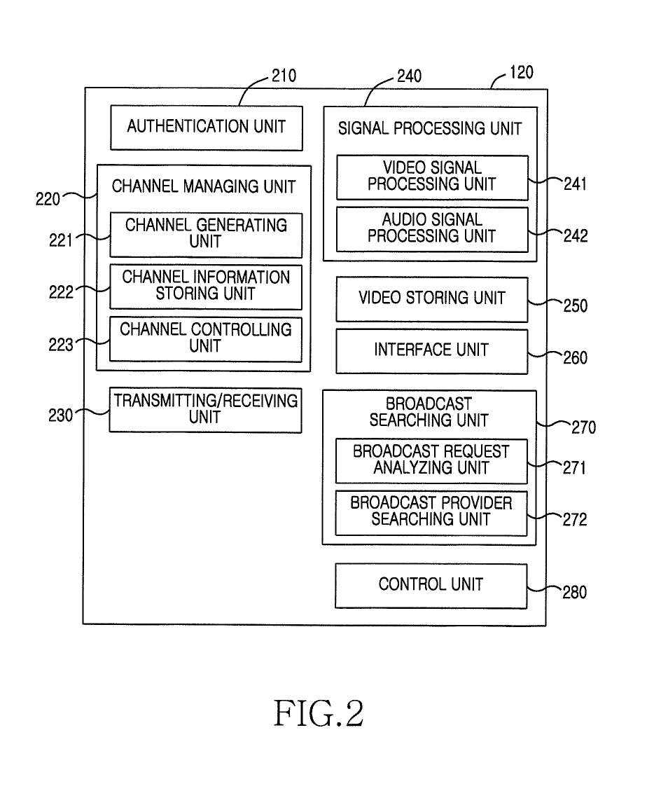

FIG. 2 illustrates an example block diagram of the personal broadcast server 120 according to an embodiment of the present invention.

Referring to FIG. 2, the personal broadcast server 120 may include an authentication unit 210, a channel managing unit 220, a transmitting/receiving unit 230, a signal processing unit 240, a video storing unit 250, an interface unit 260, a broadcast searching unit 270, and a control unit 280.

The authentication unit 210 authenticates a viewer to use a personal broadcasting service The channel managing unit 220 manages a channel for providing a personal broadcasting service. The channel managing unit 220 may include a channel generating unit 221, a channel information storing unit 222, and a channel controlling unit 223. The channel generating unit 221 generates and provides a personal broadcast channel to a requester desiring to provide a personal broadcast, and the channel information storing unit 222 stores and manages personal broadcast information provided in each channel. The channel controlling unit 223 controls the channel generating unit 221 and the channel information storing unit 222 to control channel generation and information about each channel.

The transmitting/receiving unit 230 transmits/receives personal broadcast data. The signal processing unit 240 processes signals for a personal broadcasting service. The signal processing unit 240 may include a video signal processing unit 241 and an audio signal processing unit 242. The video signal processing unit 241 processes video signals while the audio signal processing unit 242 processes audio signals.

The video storing unit 250 temporarily stores a video for a personal broadcasting service, and the interface unit 260 provides a user interface for a personal broadcasting service.

The broadcast searching unit 270 searches for the broadcast provider configured to provide a broadcast requested by the broadcast receiving terminal. The broadcast searching unit 270 may include a broadcast request analyzing unit 271 and a broadcast provider searching unit 272. The broadcast request analyzing unit 271 analyzes the request contents registered by the broadcast receiving terminal. The broadcast provider searching unit 272 searches for and selects the broadcast provider that matches the request conditions analyzed by the broadcast request analyzing unit 271.

The control unit 280 controls an overall operation of the personal broadcast server 120. The control unit 280 is configured to provide a personal broadcast viewing (receiving) service or a personal broadcast providing service through a portable terminal.

In order to view a personal broadcast, the viewer accesses the personal broadcast server 120 and performs authentication. In order to view a broadcast of a desired theme, the viewer requests a desired broadcast in accordance with a registration procedure according to an interface provided by the interface unit 260. For example, the viewer may register a desired broadcast theme in the bulletin board. Also, the viewer may register a desired broadcast by entering entries in a form classified according to multiple differing categories. The broadcast request analyzing unit 271 derives a broadcast provider search condition from the registered request content. For example, the broadcast request analyzing unit 271 may derive a search word (e.g., a region name) corresponding to the condition from an entry entered by the viewer registered in the bulletin board. Also, the broadcast request analyzing unit 271 may classify a category corresponding to the condition from the derived search word. Examples of categories may include a life, culture, and education of a broadcast. For example, if a particular derived search word represents a region name, the category may be classified as a life category. Also, the broadcast request analyzing unit 271 may give other predetermined conditions (e.g., a search radius). The broadcast provider searching unit 272 searches for the broadcast providing terminals that matches at least one of the conditions derived by the broadcast request analyzing unit 271, among the broadcast providing terminals connected to the personal broadcast server 120. Thereafter, the broadcast provider searching unit 272 notifies the searched broadcast providers of the content requested by the viewer and inquires these broadcast provider about the broadcast. The searched broadcast providers may accept or refuse the inquiry. The broadcast provider searching unit 272 selects the accepting broadcast provider as the broadcast provider for the viewer. The broadcast provider searching unit 272 may prioritize the searched broadcast providers, which will be described below in detail. The broadcast provider searching unit 272 may inquire a broadcast request of the broadcast provider with the highest priority, and then inquire a broadcast request of the broadcast provider with the second-highest priority if there is no acceptance of the broadcast provider with the highest priority. Also, the broadcast provider searching unit 272 may inquire a broadcast request of all the searched terminals, and select the highest-priority broadcast provider among the accepting broadcast providers. This prioritizing method will be described below in detail with reference to the drawings.

When the selected broadcast provider performs authentication through the authentication unit 210, the personal broadcast server 120 performs a personal broadcast registration procedure according to an interface provided by the interface unit 260. The channel generating unit 221 allocates a channel for the personal broadcast of the selected broadcast provider, and information about the channel is stored in the channel information storing unit 222. The personal broadcast server 120 may register broadcast information of the selected broadcast provider (e.g., a channel address and broadcast content) or notify the same to the corresponding viewer. The personal broadcast data transmitted through a video capturing function of the broadcast providing terminal, are processed by the signal processing unit 240, stored temporarily in the video storing unit 250, and broadcasted in real time through the allocated channel. The personal broadcast server 120 may notify the broadcast receiving terminal (viewer) of the personal broadcast by the broadcast provider. Also, the viewer may view the personal broadcast by accessing the channel address detected from the broadcast information registered in the personal broadcast server 120.

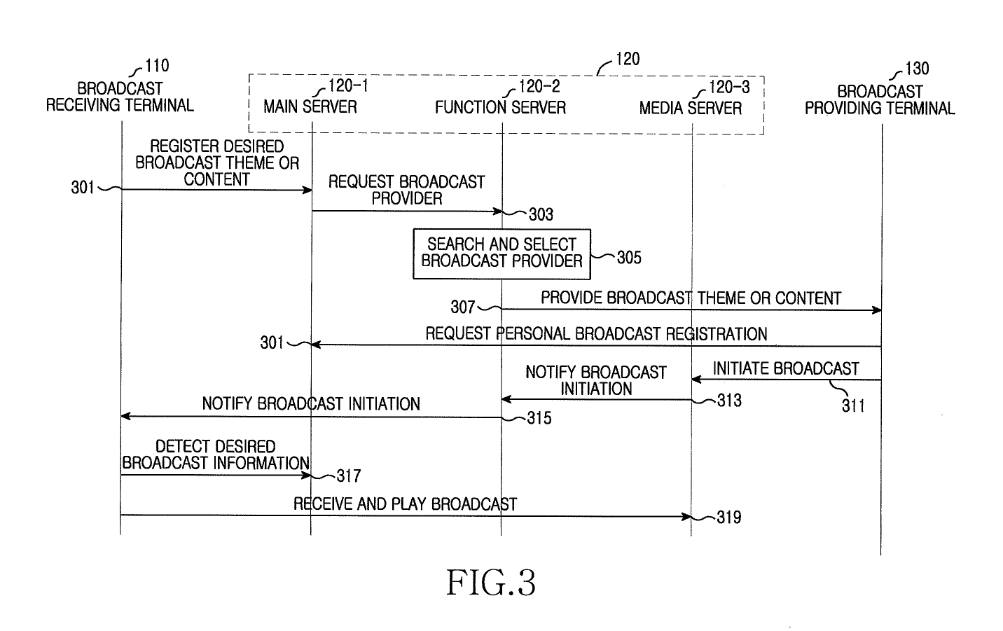

FIG. 3 illustrates an example communication flow diagram of the personal broadcast providing system according to an embodiment of the present invention. The personal broadcast server 120 illustrated in FIG. 2 may include a plurality of servers that share roles for providing a personal broadcast. For example, the personal broadcast server 120 may include a main server 120-1, a function server 120-2, and a media server 120-3. The main server 120-1 provides an interface for the terminal and stores information related to the interface. The function server 120-2 searches for and selects a particular broadcast provider that may provide a personal broadcast of a theme desired by the viewer. The media server 120-3 provides personal broadcast data associated with the broadcast providing terminal to the broadcast receiving terminal in real time, or stores the same for later use. Detailed operations of the main server 120-1, the function server 120-2 and the media server 120-3 will be described below with reference to the communication flow diagram of FIG. 3.

Referring to FIG. 3, the broadcast receiving terminal 110 registers a desired broadcast theme or content through an interface provided by the main server 120-1 in step 301. The main server 120-1 requests the broadcast provider, which may provide a personal broadcast of a theme or content desired by the broadcast receiving terminal 110, from the function server 120-2 in step 303.

The function server 120-2 derives a condition from the broadcast theme or content registered by the broadcast receiving terminal 110, and searches for and selects the broadcast providing terminal (provider) that matches the condition in step 305. Thereafter, the function server 120-2 provides the selected broadcast providing terminal 130 with the broadcast theme or content registered by the broadcast receiving terminal 110 in step 307.

When receiving the broadcast theme or content from the function server 120-2, the broadcast providing terminal 130 transmits a personal broadcast registration request to the main server 120-1 in step 309. When receiving the personal broadcast registration request, the main server 120-1 notifies the broadcast providing terminal 130 of an address of the media server 120-3 that is accessed by the broadcast receiving terminal to receive the personal broadcast. Also, when receiving the personal broadcast registration request, the main server 120-1 registers information about the broadcast content and the address of the media server 120-3 receiving personal broadcast data from the broadcast providing terminal 130. For example, the broadcast information of the broadcast providing terminal 130 is posted on the bulletin board of the main server 120-1 in accordance with the relevant interface. After this, the broadcast receiving terminal 110 may access the main server 120-1 and detect the broadcast time, the broadcast content and the address of the media server 120-3 from the broadcast information of the broadcast providing terminal 130.

The broadcast providing terminal 130 accesses the media server 120-3 and initiates a personal broadcast, that is, provides personal broadcast data, captured by the broadcast providing terminal 130, to the media server 120-3 in step 311. In step 313, the media server 120-3 notifies the function server 120-2 of the initiation of the personal broadcast, and the function server 120-2 notifies the same to the broadcast receiving terminal 110 in step 315.

When detecting the initiation of the personal broadcast from the function server 120-2, the broadcast receiving terminal 110 reads the broadcast information of the broadcast providing terminal 130 registered in the main server 120-1 in step 317. For example, the viewer may read the broadcast information of the broadcast providing terminal 130 from the bulletin board of the main server 120-1 to detect the broadcast time, the broadcast content and the address of the media server 120-3.

Thereafter, the broadcast receiving terminal 110 accesses the address of the media server 120-3, detected from the read broadcast information, to receive the personal broadcast provided by the broadcast providing terminal 130 in step 319.

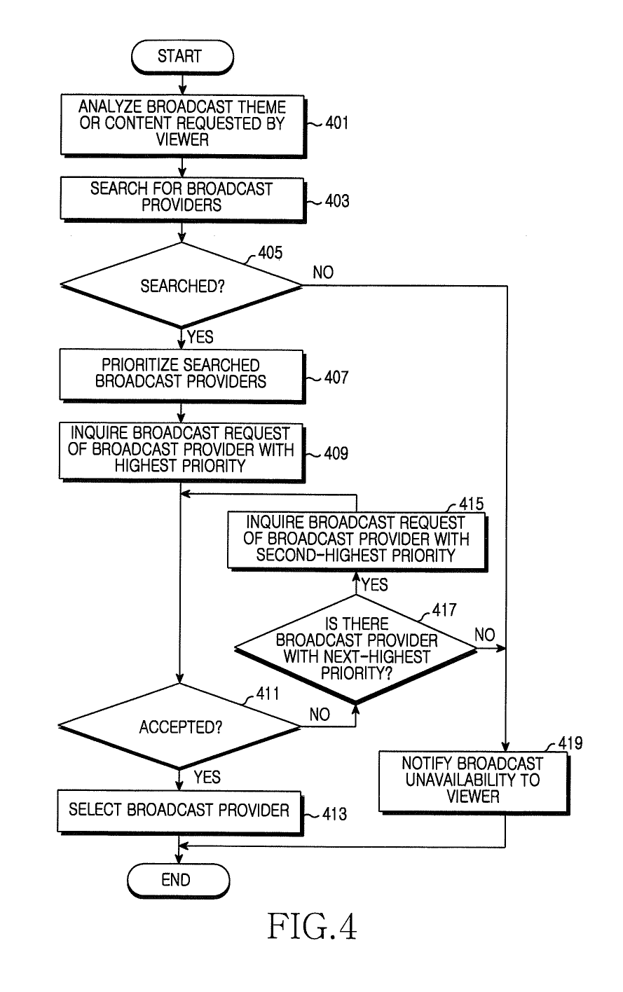

FIG. 4 illustrates an example flow diagram for a process of searching for a broadcast provider, configured to provide a broadcast of a content desired by a viewer, by the personal broadcast server 120 according to an embodiment of the present invention.

Referring to FIG. 4, the personal broadcast server 120 analyzes a broadcast theme or content requested by the viewer in step 401. That is, the personal broadcast server 120 analyzes a broadcast theme or content requested by the viewer and derives a condition for searching for the corresponding broadcast provider.

The personal broadcast server 120 searches for a broadcast provider satisfying the condition in step 403. If the broadcast provider is not searched for in step 405, the personal broadcast server 120 notifies the broadcast unavailability to the viewer in step 419. On the other hand, if the broadcast provider is searched for in step 405, the personal broadcast server 120 prioritizes the searched broadcast providers in step 407. The prioritizing method will be described below with reference to the drawings.

The personal broadcast server 120 inquires a broadcast request of the broadcast provider with the highest priority in step 409. If the broadcast provider with the highest priority accepts the broadcast request in step 411, the personal broadcast server 120 selects the broadcast provider with the highest priority as the personal broadcast provider for the viewer in step 413.

On the other hand, if the broadcast provider with the highest priority does not accept the broadcast request in step 411, the personal broadcast server 120 inquires a broadcast request of the broadcast provider with the second-highest priority in step 415. That is, the personal broadcast server 120 inquires a broadcast request of the broadcast provider with the next-highest priority until there is an accepting broadcast provider. In step 417, if there is no accepting broadcast provider and there is no broadcast provider with the next-highest priority, the personal broadcast server 120 notifies the broadcast unavailability to the viewer in step 419.

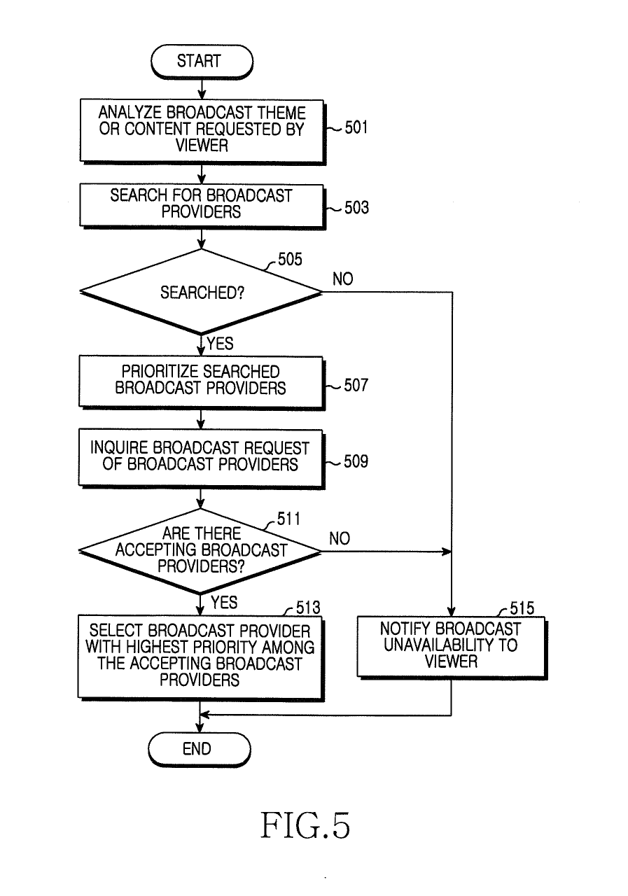

FIG. 5 illustrates an example flow diagram for a process of searching for a broadcast provider, configured to provide a broadcast of a content desired by a viewer, by the personal broadcast server 120 according to another embodiment of the present invention.

Referring to FIG. 5, the personal broadcast server 120 analyzes a broadcast theme or content requested by the viewer in step 501. That is, the personal broadcast server 120 analyzes a broadcast theme or content requested by the viewer and derives a condition for searching for the corresponding broadcast provider.

The personal broadcast server 120 searches for a broadcast provider satisfying the condition in step 503. If the broadcast provider is not searched for in step 505, the personal broadcast server 120 notifies the broadcast unavailability to the viewer in step 515. On the other hand, if the broadcast provider is searched for in step 505, the personal broadcast server 120 prioritizes the searched broadcast providers in step 507. The prioritizing method will be described below with reference to the drawings.

The personal broadcast server 120 inquires a broadcast request of the broadcast provider with the highest priority in step 509. If there are accepting broadcast providers in step 511, the personal broadcast server 120 selects the broadcast provider with the highest priority, among the accepting broadcast providers, as the personal broadcast provider for the viewer in step 513. On the other hand, if there are no accepting broadcast providers in step 511, the personal broadcast server 120 notifies the broadcast unavailability to the viewer in step 515).

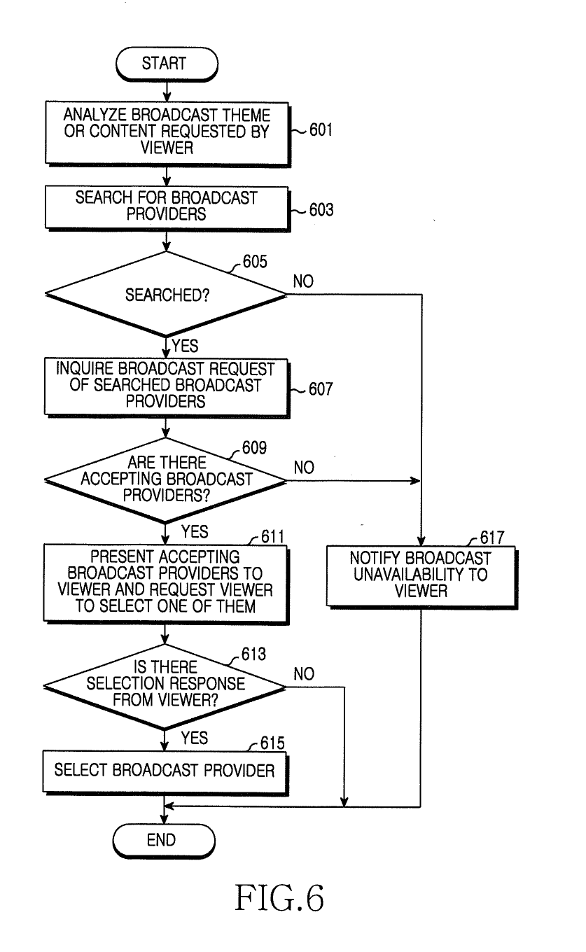

FIG. 6 illustrates an example flow diagram for a process of searching for a broadcast provider, configured to provide a broadcast of a content desired by a viewer, by the personal broadcast server 120 according to another embodiment of the present invention.

Referring to FIG. 6, the personal broadcast server 120 analyzes a broadcast theme or content requested by the viewer in step 601. That is, the personal broadcast server 120 analyzes a broadcast theme or content requested by the viewer and derives a condition for searching for the corresponding broadcast provider.

The personal broadcast server 120 searches for a broadcast provider that matches the condition in step 603. In step 605, if the broadcast provider is searched for, the personal broadcast server 120 inquires a broadcast request of the searched broadcast providers in step 607. On the other hand, in step 605, if the broadcast provider is not searched for, the personal broadcast server 120 notifies the broadcast unavailability to the viewer in step 617.

In step 609, if there are accepting broadcast providers, the personal broadcast server 120 presents the accepting broadcast providers to the viewer and requests the viewer to select one of the accepting broadcast providers in step 611. Thereafter, in step 613, if there is a selection response from the viewer, the personal broadcast server 120 selects the corresponding broadcast provider in step 615. On the other hand, in step 6113, if there is no selection response from the viewer, the personal broadcast server 120 ends the process.

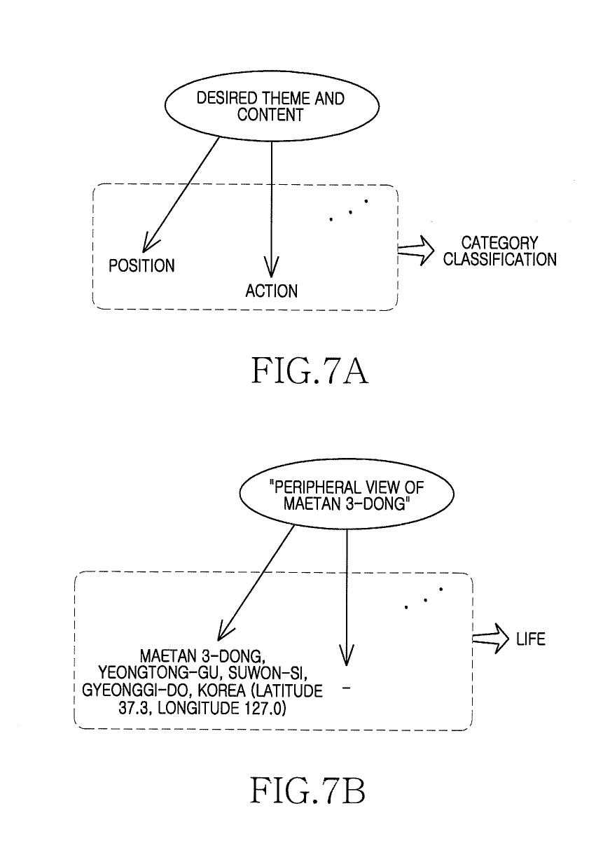

FIG. 7 illustrates an example diagram for a method of determining a search condition for a broadcast provider, configured to provide a broadcast of a theme and content desired by a viewer, by the personal broadcast server (function server) according to an embodiment of the present invention.

Referring to FIG. 7A, the personal broadcast server 120 derives a search word related to a position and an action from a desired theme or content registered by the viewer, and derives a category from the search word. The search word and the category are conditions for searching for broadcast providers.

For example, referring to FIG. 7B, when the viewer registers an entry such as ‘Peripheral View of Maetan 3-dong’ in a broadcast request bulletin board of the personal broadcast server 120, the personal broadcast server 120 derives a search word and a category from the ‘Peripheral View of Maetan 3-dong’ entry.

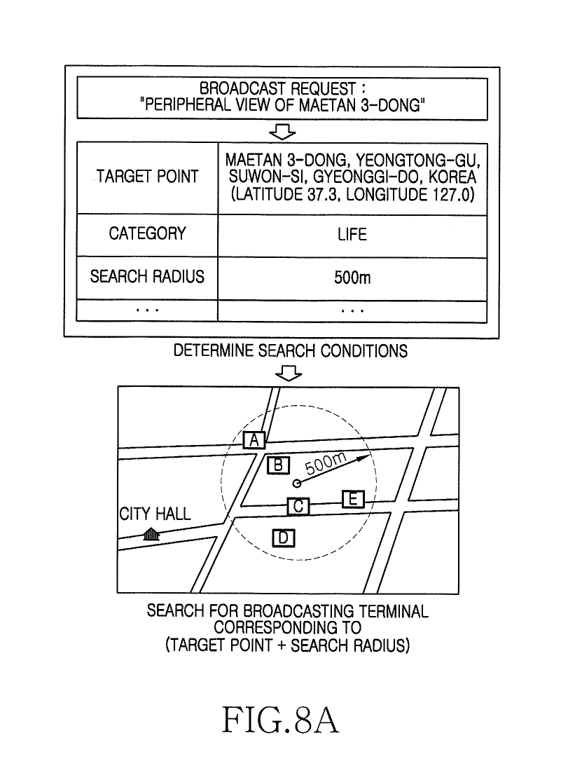

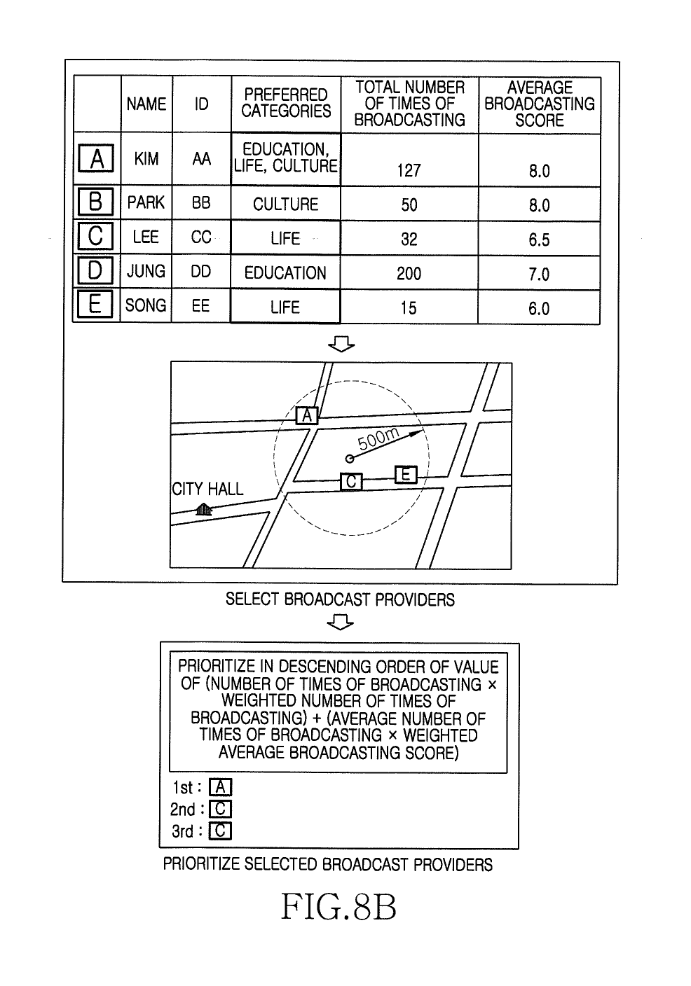

FIGS. 8A and 8B illustrate example diagrams for a method of searching for and prioritizing broadcast providers, configured to provide a broadcast of a content desired by a viewer, according to an embodiment of the present invention.

Referring to FIG. 8A, the viewer registers the content of a desired broadcast. For example, the viewer registers an entry such as ‘Peripheral View of Maetan 3-dong’ in the bulletin board. The personal broadcast server 120 derives conditions such as a target point and a category, and determines search conditions by adding a predetermined condition (e.g., a search radius).

Thereafter, the personal broadcast server 120 uses the corresponding interface to search for the broadcast providers that matches the search conditions. For example, as illustrated in FIG. 8A, the personal broadcast server 120 searches for broadcast providers A, B, C, D and E corresponding to a target point and a search radius associated with the condition.

Referring to FIG. 8B, the personal broadcast server 120 selects some of the searched broadcast providers A, B, C, D and E. For example, as illustrated in FIG. 8B, the personal broadcast server 120 selects broadcast providers of a preferred category corresponding to the derived category. Also, the viewer may select other conditions replacing the preferred category in accordance with a user environment setting interface provided by the personal broadcast server 120. Herein, the personal broadcast server 120 manages information about the names of the broadcast providers, the identification of the broadcast providers, the preferred categories, the total number of times allocated for broadcasting, and an average broadcasting score. The average broadcasting score may be the average of the scores for broadcast providers evaluated by viewers.

Thereafter, the personal broadcast server 120 prioritizes the selected broadcast providers. For example, the personal broadcast server 120 may prioritize the selected broadcast providers in descending order of the value obtained by applying weights to the number of times of that the broadcast providers have broadcasted and the average broadcasting score of the selected broadcast providers. For example, the weight applied to the number of times of broadcasting varies according to each category (e.g., education, culture and life). Because the broadcasting priority varies according to each category, a suitable importance (or weight) may be determined according to the broadcast priority of each category. Thus, the more frequently broadcast category may be given a greater weight than other categories.

Consequently, the personal broadcasting service providing method and system of the present invention enables the viewer to view a personal broadcast of a desired theme or content in a customized manner.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein

While the invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for providing a personal broadcasting service comprising:
receiving a request for a broadcast theme or content from a broadcast receiving terminal;
searching for broadcast providing terminals configured to provide a personal broadcast associated with the broadcast theme or content;
selecting one of the searched broadcast providing terminals; and
when a personal broadcast registration request is received from the selected broadcast providing terminal, providing information associated with the requested personal broadcast to the broadcast receiving terminal.

2. The method of claim 1, wherein searching for the broadcast providing terminals configured to provide the personal broadcast of the broadcast theme or content comprises:
determining at least one search condition based on the broadcast theme or content; and
determining the broadcast providing terminal that matches the search condition.

3. The method of claim 2, wherein the search condition includes at least one of a position, a search radius, and a category of the broadcast.

4. The method of claim 2, further comprising arranging the determined broadcast providing terminals in the order of a cumulative score.

5. The method of claim 4, wherein the cumulative score is the weighted sum of the number of times of the broadcast providing terminals have broadcasted and the average broadcasting score of the determined broadcast providing terminals.

6. The method of claim 1, further comprising:
providing the broadcast theme or content to the searched broadcast providing terminals; and
determining whether a personal broadcast registration request is received from the broadcast providing terminals.

7. The method of claim 1, further comprising searching for the corresponding broadcast providing terminal again if a personal broadcast registration request is not received from the selected broadcast providing terminal.

8. The method of claim 1, wherein selecting one of the searched broadcast providing terminals comprises:
prioritizing the searched broadcast providing terminals;
inquiring a broadcast request of one search broadcast providing terminal having a highest priority;
repeatedly inquiring a broadcast request of another broadcast providing terminal having the next highest priority until there is an accepting broadcast providing terminal; and
selecting the broadcast providing terminal accepting the inquiry.

9. The method of claim 1, wherein selecting one of the searched broadcast providing terminals comprises:
prioritizing the searched broadcast providing terminals;
inquiring a broadcast request of all the searched broadcast providing terminals; and
selecting the broadcast providing terminal with the highest priority among the broadcast providing terminals accepting the inquiry.

10. The method of claim 1, wherein selecting one of the searched broadcast providing terminals comprises:
inquiring a broadcast request of all the searched broadcast providing terminals;
presenting the broadcast providing terminals accepting the inquiry to the broadcast receiving terminal;
requesting the broadcast receiving terminal to select one of the accepting broadcast providing terminals; and
selecting the broadcast providing terminal corresponding to a selection response from the broadcast receiving terminal.

11. A system for providing a personal broadcasting service, comprising:
a broadcast receiving terminal configured to request a broadcast from a server;
a broadcast providing terminal configured to transmit a personal broadcast registration request to the server; and
a server configured to receive a request for a broadcast theme or content from the broadcast receiving terminal, and search for and select broadcast providing terminals configured to provide a personal broadcast associated with the broadcast theme or content; and
wherein when the personal broadcast registration request is received from the selected broadcast providing terminal, the server provides information associated with the requested personal broadcast to the broadcast receiving terminal.

12. The system of claim 11, wherein the server is configured to search for the broadcast providing terminals configured to provide the personal broadcast of the broadcast theme or content, determine at least one search condition based on the broadcast theme or content, and determine the broadcast providing terminal that matches the search condition.

13. The system of claim 12, wherein the search condition includes at least one of a position, a search radius, and a category of the broadcast.

14. The system of claim 12, wherein the server is configured to arrange the determined broadcast providing terminals in the order of a cumulative score.

15. The system of claim 14, wherein the cumulative score is the weighted sum of the number of times of that the broadcast providing terminals have broadcasted and the average broadcasting score of the determined broadcast providing terminals.

16. The system of claim 11, wherein the server is configured to provide the broadcast theme or content to the searched broadcast providing terminals, and determine whether a personal broadcast registration request is received from the broadcast providing terminals.

17. The system of claim 11, wherein the server is configured to search for the corresponding broadcast providing terminal again if a personal broadcast registration request is not received from the selected broadcast providing terminal.

18. The system of claim 11, wherein the server is configured to prioritize the searched broadcast providing terminals, inquire a broadcast request of the broadcast providing terminals having the highest priority until there is an accepting broadcast providing terminal, and select the highest broadcast providing terminal accepting the inquiry.

19. The system of claim 11, wherein the server is configured to prioritize the searched broadcast providing terminals, inquire a broadcast request of all the searched broadcast providing terminals, and select the broadcast providing terminal with the highest priority among the broadcast providing terminals accepting the inquiry.

20. The system of claim 11, wherein the server is configured to inquire a broadcast request of all the searched broadcast providing terminals, present the broadcast providing terminals accepting the inquiry to the broadcast receiving terminal, request the broadcast receiving terminal to select one of the accepting broadcast providing terminals, and select the broadcast providing terminal corresponding to a selection response from the broadcast receiving terminal.

21. A computer readable medium embodying a computer program, the computer program comprising computer readable program code for:
searching for broadcast providing terminals configured to provide a personal broadcast associated with the broadcast theme or content;
selecting one of the searched broadcast providing terminals; and
when a personal broadcast registration request is received from the selected broadcast providing terminal, providing information associated with the requested personal broadcast to the broadcast receiving terminal.
